(19) United States
(12) Patent Application Publication
(10) Pub. No.: US 2005/0286946 A1
(43) Pub. Date: Dec. 29, 2005

(54) Apparatus for moisturizing an image recording medium and an image forming apparatus

(75) Inventors: Masashi Kougami, Saitama-shi (JP); Hisao Satoh, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/155,576

(22) Filed: Jun. 20, 2005

(30) Foreign Application Priority Data
Jun. 23, 2004 (JP) JP2004-184848

(51) Int. Cl. G03G 15/00

(52) U.S. Cl. 399/390

(57) ABSTRACT

This invention discloses a paper moisturizing apparatus comprising a pair of moisturizing rollers which respectively has a porous layer and form a nip area to deliver paper, a water-supplying device which supplies water to at least one of the moisturizing rollers from the surface of the roller, and, a regulating device which regulates the quantity of water to be supplied to the moisturizing roller from the water-supplying device, and an image forming apparatus using the paper moisturizing apparatus.

### BACKGROUND

1. Field of the Invention

This invention relates to an electrophotographic image forming apparatus, particularly, relates to a moisturizing technology which moisturizes paper fixed by a thermal fixing device.

2. Related Art

An image forming apparatus which forms images by an electrophotographic process forms an image with fine toner particles on paper and fixes the toner image by heating and pressing thereof.

When paper is heated to fix a toner image thereon, the paper loses its moisture by evaporation. When the fixed paper is exposed to a surrounding atmosphere, the paper gradually recovers moisture. However, this moisture recovery is not uniform on the paper. For example, when some sheets of paper are stacked up, the moisture absorbing rate is great near the edges of the stacked sheets but small or little in the center of the stacked sheets.

Therefore, each paper sheet has different moisture contents thereon and this difference in moisture contents causes the paper sheet to wave.

This paper waving phenomenon often takes place on the image-recorded paper sheets which are stacked on the paper-ejection tray or on the stapling stacker. Particularly, it is remarkable on paper sheets on a paper-ejection tray which consists of large-quantity stackers.

In some cases, paper sheets are curved or curled.

Patent Document 1 proposes a paper moisturizing apparatus for preventing paper curls by using a porous moisturizing roller to deliver paper, supplying water from the center of the shaft of the moisturizing roller, and moisturizing the paper.

[Patent Document 1]
U.S. Pat. No. 5,264,899

### SUMMARY

With a view to the above, an object of this invention is to provide a useful recording medium moisturizing apparatus and an image forming apparatus.

A first aspect is a paper moisturizing apparatus comprising
a pair of porous moisturizing rollers which form a nip area to deliver paper,
a water-supplying device which supplies water to at least one of the moisturizing rollers from the surface of the roller, and
a regulating device which regulates the quantity of water to be supplied to the moisturizing roller from the water-supplying device.

A second aspect is a recording medium moisturizing apparatus comprising a first and second moisturizing member each of which has a porous layer, wherein a recording medium is delivered by the first and second moisturizing members and the moisturizing apparatus further comprises
a water-supplying device which supplies water to at least one of the moisturizing members from the surface thereof, and
a regulating device which regulates the quantity of water to be supplied to the moisturizing roller from the water-supplying device.

A third aspect is an image forming apparatus comprising
an image forming section which transfers toner onto paper to form an image on the paper,
a fixing device which heats and presses the paper having a toner image on it to fix the image, and
the moisturizing apparatus of the above first or second aspect.

### BRIEF DESCRIPTION OF THE DRAWINGS

The present invention will become more fully understood from the detailed description given herein below and the accompanying drawings which are given by way of illustration only, and thus are not intended as a definition of the limits of the present invention, and wherein;

FIG. 1 is the view of the whole image forming apparatus which is an embodiment of this invention.

FIG. 2 shows a moisturizing apparatus which is a first embodiment of this invention.

FIG. 3 shows a moisturizing apparatus which is a second embodiment of this invention.

FIG. 4 shows a moisturizing apparatus which is a third embodiment of this invention.

FIG. 5 shows a moisturizing apparatus which is a fourth embodiment of this invention.

FIG. 6 shows a moisturizing apparatus which is a fifth embodiment of this invention.

FIG. 7 shows a moisturizing apparatus which is a sixth embodiment of this invention.

FIG. 8 shows a moisturizing apparatus which is a seventh embodiment of this invention.

FIG. 9 shows a paper-ejection section in an image forming apparatus which is another embodiment of this invention.

### DETAIL DESCRIPTION OF THE EXEMPLARY EMBODIMENTS

For a view to the above, moisturizing apparatus having the configuration below have proven useful.

A first aspect is a paper moisturizing apparatus comprising
a pair of porous moisturizing rollers which form a nip area to deliver paper,
a water-supplying device which supplies water to at least one of the moisturizing rollers from the surface of the roller, and
a regulating device which regulates the quantity of water to be supplied to the moisturizing roller from the water-supplying device.

It is preferable that the water-supplying device in the configuration is equipped with a water-supplying roller with a porous layer and supplies water to the moisturizing roller while the water-supplying roller rotates in contact with the moisturizing roller.

It is preferable that the regulating device is equipped with a regulating member which is in press-contact with the water-supplying roller and regulates the quantity of water in the water-supplying device. This configuration does not let the regulating member press the moisturizing roller and consequently can prevent deformation of the moisturizing roller.

The regulating member should preferably be able to move to touch and detach from the water-supplying roller. This configuration can prevent deformation of the water-supplying roller due to the continuous pressure to the roller by the regulating member.

Further, the regulating device can be a member which regulates the quantity of water in the moisturizing roller in press-contact with the moisturizing roller. The regulating member should be able to move to touch and detach from the moisturizing roller to prevent deformation of the moisturizing roller due to the continuous pressure to the moisturizing roller by the regulating member.

The water-supplying device may have a container to store water in which the water-supplying roller is dipped. The water-supplying device can comprise a water-supplying roller and an intermediate roller which is in contact with the water-supplying roller and at least one of the moisturizing rollers. In other words, for example, the moisturizing apparatus comprises a pair of moisturizing rollers each of which has a porous layer and forms a nip area to deliver paper, an intermediate roller which supplies water to at least one of the moisturizing rollers in contact therewith from the surface of the moisturizing roller, and a water-supplying device which supplies water to the intermediate roller. The intermediate roller can move to a position to be in contact with the moisturizing roller and the water-supplying roller and move away from at least one of the moisturizing roller and the water-supplying roller. In other words, the intermediate roller can be configured so that it can move to a position to be in contact with the moisturizing roller and the water-supplying roller and move away from at least one of the moisturizing roller and the water-supplying roller.

This configuration of the water-supplying device can exactly control supply and shut-off of water to the pair of moisturizing rollers. Therefore, this configuration can prevent excessive water supply to the moisturizing roller pair and suppress the occurrence of a problem due to excessive water supply.

For example, if water is supplied to the moisturizing roller which stopped, the excessive water will be given to the paper from the moisturizing roller when the moisturizing roller starts to rotate again. This will make the paper too wet.

In at least one of the above configurations, the moisturizing roller pair detachable to each other is one of the preferable configurations because it can prevent the deformation of the moisturizing roller.

The above configuration of the moisturizing apparatus has excellent effects in fully preventing the deformation of paper, applying uniform moisture to the whole paper, and facilitating moisture supply control. Further, this configuration can reduce the number of water-storage sections and downsize the apparatus. Naturally, the downsized configuration can be housed in the image forming apparatus easily. In summary, the first aspect of this invention is preferably applied to the image forming apparatus.

A second aspect is a recording medium moisturizing apparatus comprising a first and a second moisturizing members each of which has a porous layer, wherein a recording medium is delivered by the first and the second moisturizing members and the moisturizing apparatus further comprises
a water-supplying device which supplies water to at least one of the moisturizing members from the surface of the member, and
a regulating device which regulates the quantity of water to be supplied to the moisturizing roller from the water-supplying device.

The preferable configuration of the second aspect has the same as the first aspect, and has the same advantages.

The third aspect is an image forming apparatus comprising
an image forming section which transfers toner onto paper to form an image on the paper,
a fixing device which heats and presses the paper having a toner image on it to fix the image, and
the moisturizing apparatus of the above first or second aspect.

It is preferable that the third aspect further comprises a post-processing device which post-processes the moist paper moisturized by the moisturizing apparatus.

A phenomenon which causes paper sheets to be attached together (so-called “tacking”) takes place when paper sheets are stacked with their toner resin hardened insufficiently. The above image forming apparatus can preferably prevent such a phenomenon since the image forming apparatus can give adequate moisture to the fixed paper sheets.

In a double-sided image formation, a paper sheet loses its moisture by heat of thermal-fixing of an image on one side of the paper sheet and becomes dried and highly resistant. This dried and resistant paper sheet is fed again into the image forming section to receive another image transfer on the opposite side of the sheet. Consequently, the image on the opposite side of the paper may be deteriorated. The third aspect can preferably prevent such an unwanted phenomenon by adequately moisturizing the fixed paper to control the percentage of moisture content of the paper.

By using one or more configurations of the above, it is possible to give uniform moisture to the whole paper since water is supplied from the surface of the moisturizing roller and the quantity of supplied water is regulated exactly. Further, these configurations can improve the ability to control start and stop of operations and consequently optimize paper moisture control. This can preferably suppress paper deformations such as waves and curls and further prevent paper deformations on small-sized image forming apparatus.

This invention will be described in detail with reference to the accompanying drawings in which:

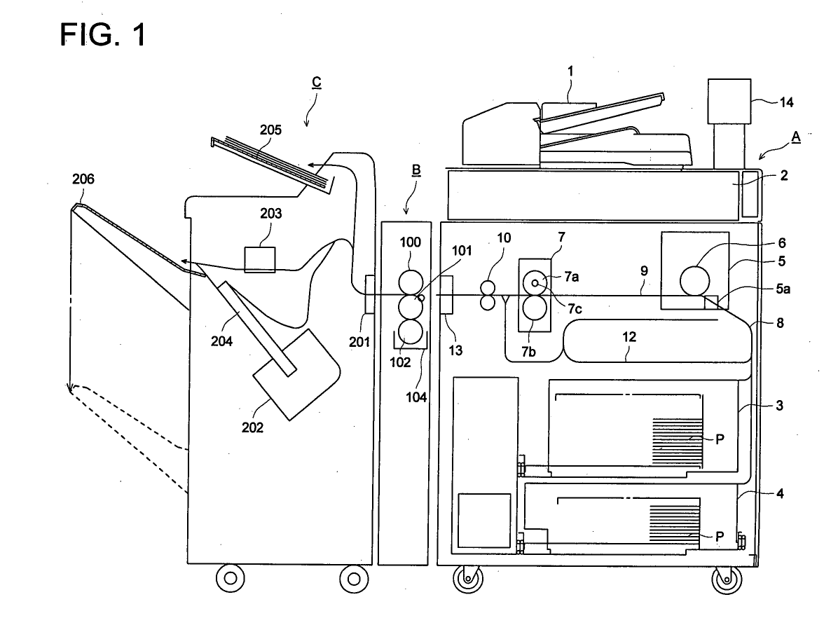

FIG. 1 is the view of the whole image forming apparatus which is an embodiment of this invention. The image forming apparatus comprises a main body of image forming apparatus A, moisturizing apparatus B, and post-processing device C.

The main body of the image forming apparatus A consists of automatic document feeder 1, image scanner 2 in the upper part, and a printer section in the lower part. Paper storage sections 3 and 4 in the printer section store paper sheets P. Image forming section 5 houses photoconductive member 6 which is charged, exposed, and developed by an electrophotographic process. A toner image is formed on the photoconductive member 6, transferred onto a piece of paper P, and fixed by a fixing device 7. The fixing device 7 contains heating roller 7a which houses heat source 7c and pressing roller 7b. These rollers form a nip area to deliver paper P. The fixing device 7 melts a toner image and fixes it the paper by heating and pressing the paper while delivering it.

A sheet of paper P is supplied from the paper storage section 3 or 4, temporarily held by paper feed section 5a in the image forming section 5, and delivered therefrom to receive a toner image. The printed paper P is carried out from ejection port 13 by ejection rollers 10.

A paper delivery path consists of
paper supply path 8 between the paper storage section 3 or 4 and the image forming section 5,
paper delivery path 9 running from the image forming section 5 towards the ejection port 13 via the fixing device 7 and paper-ejection rollers 10, and
reversing path 12 which turns over the paper upside down.

There provided are three image forming modes: Single-Sided Face-Down Ejection mode, Single-Sided Face-Up Ejection mode, and Double-Sided Print mode. In the Single-Sided Face-Down Ejection mode, a paper sheet P is printed an image on one side of the paper, fixed by the fixing device 7, turned over upside down by the reversing means, and carried out to the outside by the ejection rollers 10.

In the Single-Sided Face-Up Ejection mode, a printed paper sheet P having an image on one side of the paper is carried along the delivery path 9 and carried out directly to the outside by the ejection rollers 10.

In the Double-Sided Print mode, a paper sheet P is printed an image on one side of the paper, fixed by the fixing device 7, carried downward into the reversing path 12, turned over upside down there, and fed back to the paper supply path 8.

The printed paper sheet P having an image on one side of the paper is printed another image on the opposite side of the paper, fixed by the fixing device 7, and carried out to the outside by the ejection rollers 10. Operation section 14 is provided to set print modes of the main body of the image forming apparatus A and output modes of the post-processing device C.

The paper P ejected from the main body of the image forming apparatus A is delivered to the post-processing device C via the moisturizing apparatus B. The moisturizing apparatus B will be explained later.

The post-processing device C comprises stapling section 202, shifting section 203, and intermediate stacker 204. The post-processing device C staples or shifts paper sheets and ejects them to elevating paper tray 206.

The post-processing device C further comprises stationary paper tray 205 for a small-quantity printing job. The tray 205 stacks a little amount of paper.

For stapling, a preset number of paper sheets are stacked on intermediate stacker 204 and stapled by the stapling section 202. A set of stapled paper sheets moves up above the stacker 204 and is ejected to the elevating ejection tray 206.

For a small-quantity printing job, paper sheets P fed from inlet port 201 are ejected to the stationary ejection tray 205.

When a large-quantity printing job is implemented, paper sheets P are ejected to the elevating ejection tray 206 even in a mode which does not require post-processing (stapling or shifting).

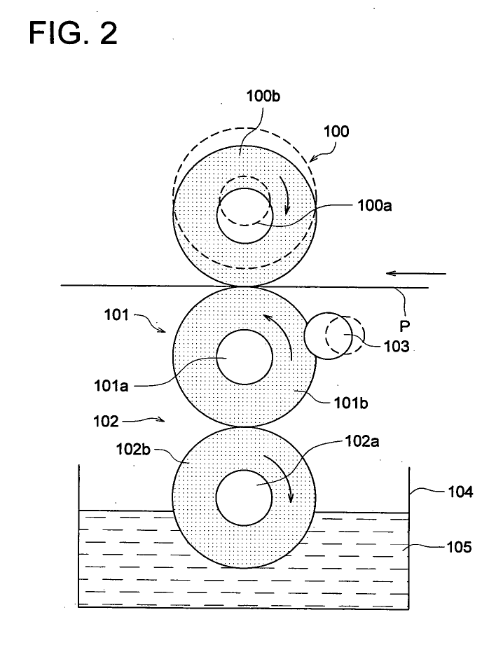

FIG. 2 shows a moisturizing apparatus B which is the first embodiment of this invention.

In FIG. 2, moisturizing rollers 100 and 101 are used to moisten paper sheets. Each moisturizing roller 100 or 101 is prepared by forming a porous layer 100b or 101b such as a porous urethane rubber layer around a solid metallic or resin shaft 100a or 101a. The porous layer 100b or 101b forms a porous surface which receives water and moistens paper P. Water-supplying roller 102 is a water-supplying device which is in contact with the lower part of the moisturizing roller 101 to supply water thereto. It is preferable that the water-supplying roller 102 is prepared by forming a porous layer 102b such as a porous urethane rubber layer around a solid metallic or resin shaft 102a. The water-supplying roller 102 is provided to be in contact with water 105 in water container 104. A roller or pad made of a porous material without a shaft 102a can be used as the water-supplying roller 102. Although it is preferable that the water-supplying roller 102 has a porous layer 102b to quickly supply water to the moisturizing roller 101 when the apparatus starts, the porous layer is not always required. The roller 101 can be made of a material whose surface does not absorb water but is hydrophilic to retain water, such as metal, hydrophilic resin or solid rubber. Regulating member 103 constitutes a regulating device and is made of a rod-like solid metallic or rigid plastic resin. The regulating member 103 regulates the quantity of water in the surface of the porous layer 101b of the moisturizing roller 101 in contact therewith and consequently regulates the quantity of water to be applied to paper P. In other words, the regulating member 103 is in press-contact with the porous layer 101b of the moisturizing roller 101 and deforms the porous layer 101b to squeeze water from the layer 101b. As the result, the quantity of water to be supplied to paper P is regulated appropriately. This can apply adequate moisture to paper and prevent the paper from being wet too much. The moisture degree can be optimized by controlling the pressing force of the regulating member 103.

The moisturizing rollers 100 and 101 and the water-supplying roller 102 are driven by a motor (which is not shown in the drawing) to rotate in the arrow direction and deliver the paper P. During the delivery, the paper P is nipped by the moisturizing rollers 100 and 101 and delivered. The paper is moistened with water which exudes from the porous layers of the moisturizing rollers 100 and 101 in the nip area. The quantity of water to be applied to the paper P is adequately regulated by squeezing of the regulating member 103.

Although the regulating member 103 regulates the quantity of water to be supplied to the moisturizing roller 101 in press-contact therewith, it is possible to make the regulating member 103 to be driven to rotate by the moisturizing roller 101 or to make the regulating member 103 just press against the moisturizing roller 101 without rotating itself. The pressing force of the regulating member 103 can be determined adequately. Further, although water of the water-supplying roller 102 is supplied to the lower moisturizing roller 101, it is possible to supply water to the upper moisturizing roller 100 or to both upper and lower moisturizing rollers 100 and 101.

As the delivered paper P is adequately moistened by this regulation of water supply to the moisturizing rollers 100 and 101, it is possible to prevent various paper problems such as paper waves due to improper moistening, adhesion of stacked paper sheets due to excessive moisture, and unwanted transfer of toner to members which is in contact with the printed paper or to the succeeding paper.

The moisturizing roller 100 can be moved up to a position indicated by a dotted line. In other words, when the image forming apparatus stops, the moisturizing roller 100 retracts to the position indicated by a dotted line apart from the moisturizing roller 101. This can prevent the deformation of the moisturizing rollers 100 and 101. Similarly, when the image forming apparatus stops, the regulating member 103 is moved to the position indicated by a dotted line apart from the moisturizing roller 101. This can prevent the deformation of the moisturizing rollers 100 and 101.

It is possible to control the quantity of water to be applied to the paper P by changing the size of the nipping area between the moisturizing rollers 100 and 101, that is, the length of the nipping area along the movement of the paper P. Similarly, the quantity of water to be applied to the paper P can be controlled by changing the pressure onto the regulating member 103.

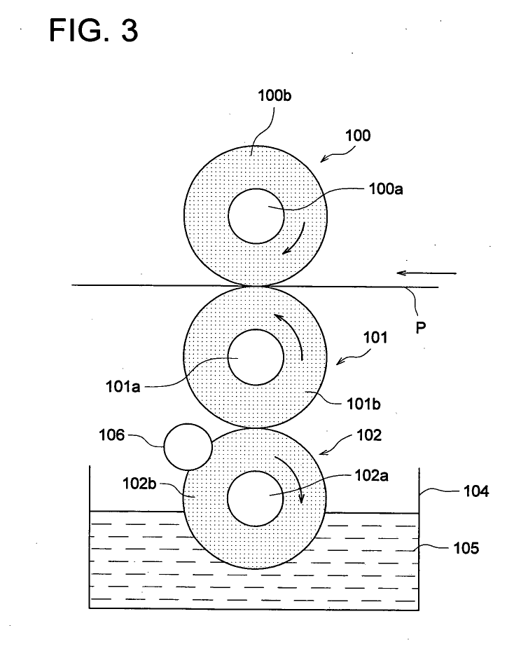

FIG. 3 shows a moisturizing apparatus which is the second embodiment of this invention.

In the second embodiment, a regulating member 106 is in press-contact with the water-supplying roller 102. As the regulating member is in press-contact with the water-supplying roller 102 instead of the moisturizing roller 101 to regulate the quantity of water to be supplied to the water-supplying roller 102, the deformation of the moisturizing roller 101 can be prevented.

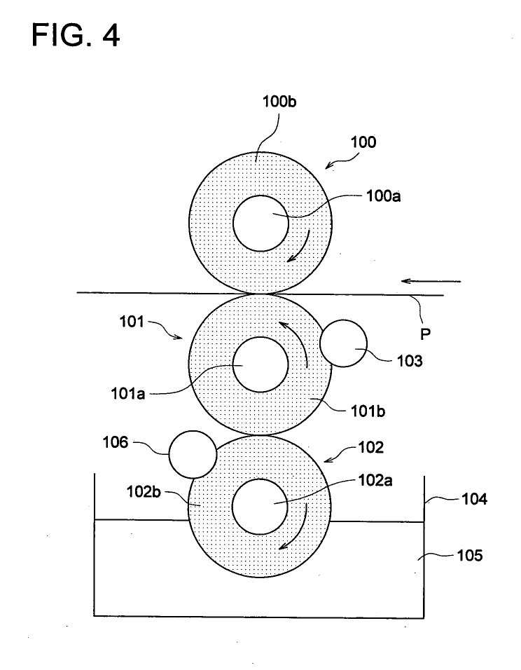

FIG. 4 shows a moisturizing apparatus which is the third embodiment of this invention.

In the third embodiment, a regulating device comprises regulating members 103 and 106. The first regulating member 103 is made in press-contact with the moisturizing roller 101 to regulate the quantity of water in the moisturizing roller 101. Similarly, the second regulating member 106 is made in press-contact with the water-supplying roller 102 to regulate the quantity of water in the water-supplying roller 102. Using two regulating members 103 and 106 enables exact control of the quantity of water to be supplied to the paper P. With this, paper P can keep the best condition.

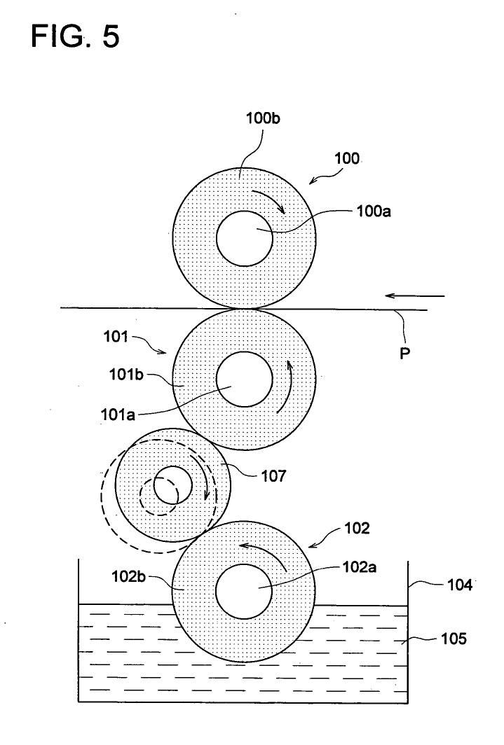

FIG. 5 shows a moisturizing apparatus which is the fourth embodiment of this invention.

In the fourth embodiment, the water-supplying device comprises water-supplying roller 102 and intermediate roller 107. The intermediate roller 107 is placed between the lower moisturizing roller 101 and the water-supplying roller 102. The intermediate roller 107 works to receive water from the water-supplying roller 102 and supplies water to the moisturizing roller 101. It is preferable that the intermediate roller 107 has a porous layer thereon, but the porous layer can be substituted by a hydrophilic non-porous roller which can retain water in its surface. The intermediate roller 107 can move to a retracted position (indicated by a dotted line) which is away from the moisturizing roller 101. The intermediate roller 107 is in the service position (indicated by a solid line) when the image forming apparatus is running but retracts to the dotted position when the image forming apparatus stops. In the example of FIG. 5, the intermediate roller 107 is in contact with the water-supplying roller 102 but away from the moisturizing roller 101. However, it is possible to retract the intermediate roller 107 away from the water-supplying roller 102 while the roller 107 is in contact with the moisturizing roller 101 or to retract the intermediate roller 107 away from both moisturizing roller 101 and the water-supplying roller 102.

This can prevent an uneven water supply to paper P when the stopped image forming apparatus starts again. When the image forming apparatus stops, the moisturizing roller 101 stops, too. If water is supplied to this stopped moisturizing roller 101, the quantity of water is not even on the moisturizing roller 101. This will unevenly moisten the paper P when the moisturizing roller 101 starts to rotate again. Further, when the moisturizing rollers 100 and 101 are driven to rotate without paper P, this can prevent excessive water supply to the moisturizing rollers 100 and 101 and keep the adequate water content on the rollers 100 and 101.

As explained in the first embodiment of FIG. 2, it is possible to make the intermediate roller 107 in contact with the moisturizing roller 100 or the intermediate rollers 107 with both moisturizing rollers 100 and 101.

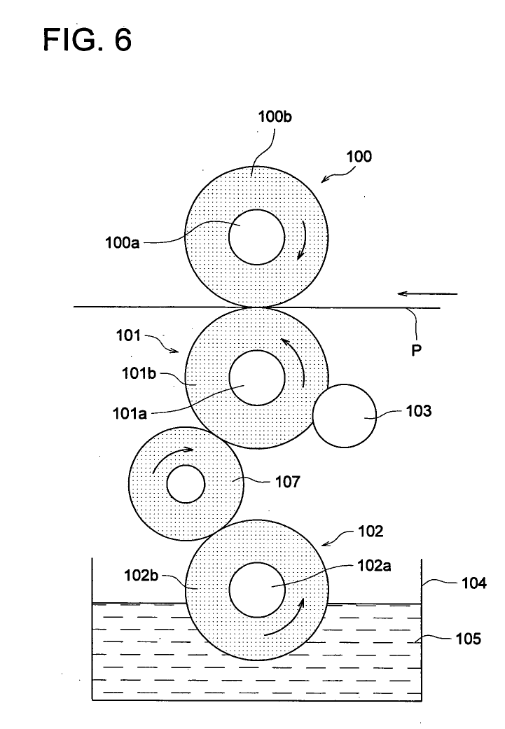

FIG. 6 shows a moisturizing apparatus which is the fifth embodiment of this invention.

In this embodiment, the intermediate roller 107 is provided between the moisturizing roller 101 and water-supplying roller 102, and the regulating member 103 is in press-contact with the moisturizing roller 101 to regulate water supply to paper P. This embodiment can optimize water supply to paper P and prevent excessive water supply to the moisturizing rollers 100 and 101.

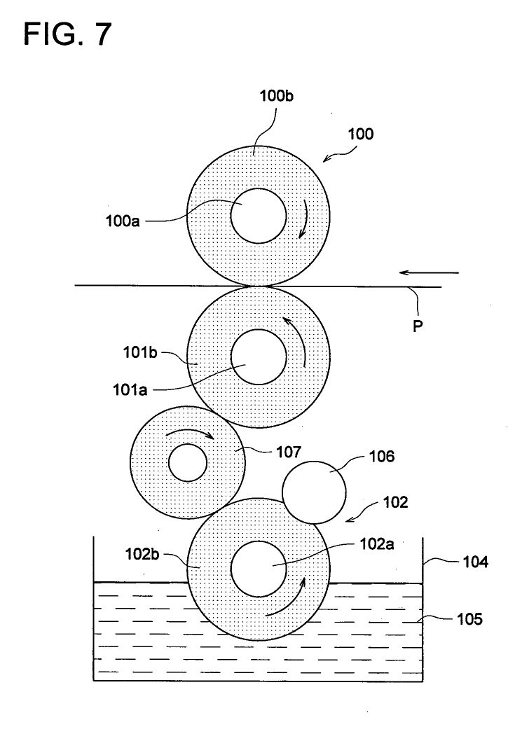

FIG. 7 shows a moisturizing apparatus which is the sixth embodiment of this invention.

In this embodiment, the intermediate roller 107 is provided between the moisturizing roller 101 and water-supplying roller 102, and the regulating member 106 is in press-contact with the water-supplying roller 102 to regulate water supply to paper P. This embodiment can optimize water supply to paper P and prevent excessive water supply to the moisturizing rollers 100 and 101.

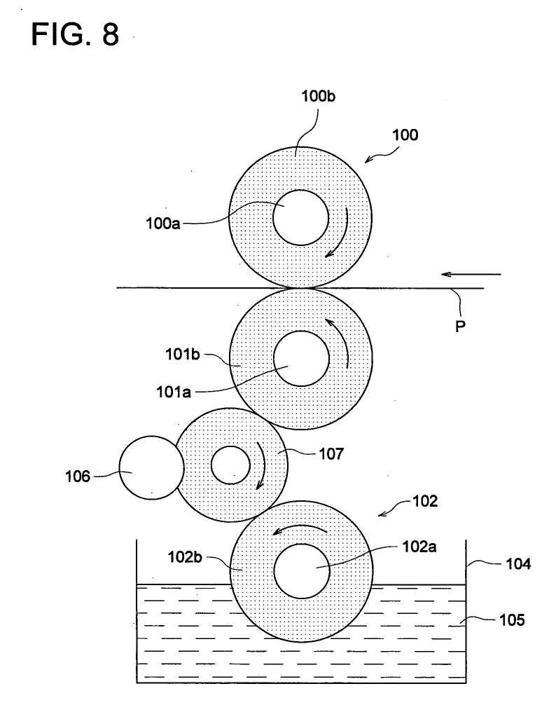

FIG. 8 shows a moisturizing apparatus which is the seventh embodiment of this invention.

In this embodiment, the intermediate roller 107 is provided between the moisturizing roller 101 and water-supplying roller 102, and the regulating member 106 is in press-contact with the intermediate roller 107 to regulate water supply to paper P. This embodiment can optimize water supply to paper P and prevent excessive water supply to the moisturizing rollers 100 and 101.

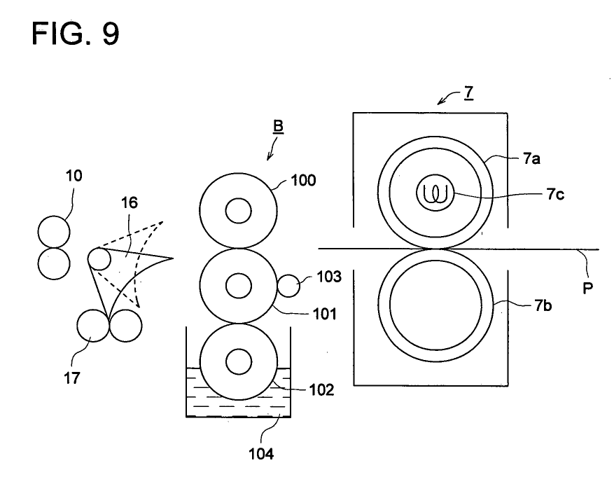

It is also possible to provide the moisturizing apparatus in the downstream side of the fixing device in the image forming apparatus. FIG. 9 shows a paper-ejection section in such an embodiment of this invention.

In this embodiment, the moisturizing apparatus B is provided between fixing device 7 and switching gate 16.

The switching gate 16 receives paper P from the fixing device 7 and works to guide the paper straight to ejection rollers 10 when the switching gate 16 is in the position indicated by a solid line or to guide downward when the switching gate 16 is in the position indicated by a dotted line. As already explained, in the Single-Sided Face-Down Ejection mode, the fixed paper is sent downward from the fixing device 7, turned over and moved up by the reversing rollers 17, guided to the ejection rollers 10 by the switching gate 16, and ejected to the outside. In the Single-Sided Face-Up Ejection mode, the fixed paper from the fixing device 7 is guided straight to the ejection rollers 10 by the switching gate 16 and ejected to the outside. In the Double-Sided Print mode, a paper sheet P is printed an image on one side of the paper, fixed by the fixing device 7, guided downward into the reversing path 12 by the switching gate, fed back to the image forming section 5, printed another image on the opposite side of the paper, guided straight to the ejection rollers 10 by the switching gate 16 and ejected to the outside. The switching gate 16 is driven to rotate and select a guide position (indicated by a solid or dotted line) by a solenoid (not shown in the drawing). Three guide positions are provided: a guide position to guide paper P straight to the ejection rollers 10, a guide position to guide paper P downward, and a guide position to guide the paper P from downward to the ejection rollers 10. The position indicated by a solid line is to guide paper P straight to the ejection rollers 10. The position indicated by a dotted line is to guide paper P from downward to the ejection rollers 10. The switching gate 16 in the dotted position is energized counterclockwise by a spring (not shown in the drawing) to switch between the guide position to guide paper P downward and the guide position to guide the paper P from downward to the ejection rollers 10. When running downward, the paper P pushes the switching gate 16 to open.

In the double-sided printing, this configuration passes the paper having an image on one side of the paper through the moisturizing apparatus B to moisten the paper before forming another image on the opposite side of the paper. This enables formation of images of the uniform quality on both side of the paper.

Although the above descriptions use water to moisten paper, it is possible to add other ingredients such as a surface-active agent to the water. Further, it is apparent that the rollers in the moisturizing and water-supplying device can be substituted by the other means such as endless belts and pads.

1. A paper moisturizing apparatus comprising:
a pair of moisturizing rollers which form a nipping area to deliver paper;
a water-supplying device which supplies water to at least one of the moisturizing rollers from the surface thereof; and
a regulating device which regulates the quantity of water to be supplied from the water supplying device to the moisturizing roller.

2. The paper moisturizing apparatus of claim 1, wherein the water-supplying device comprises a water-supplying roller which has a porous layer and supplies water to the moisturizing roller in contact therewith while the water-supplying roller rotates.

3. The paper moisturizing apparatus of claim 2, wherein the regulating device comprises a regulating member which is in press-contact with the water supplying roller and regulates the quantity of water in the water-supplying device.

4. The paper moisturizing apparatus of claim 3, wherein the regulating member can move to touch and detach from the water-supplying roller.

5. The paper moisturizing apparatus of claim 1, wherein the regulating device comprises a regulating member which is in press-contact with the moisturizing roller and regulates the quantity of water in the moisturizing roller.

6. The paper moisturizing apparatus of claim 5, wherein the regulating member can move to touch and detach from the moisturizing roller.

7. The paper moisturizing apparatus of claim 2, wherein the water-supplying device comprises a container of water in which the water-supplying roller dips.

8. The paper moisturizing apparatus of claim 1, wherein the water-supplying device comprises a water-supplying roller and an intermediate roller which is in contact with the water-supplying roller and at least one of the moisturizing rollers.

9. The paper moisturizing apparatus of claim 8, wherein the intermediate roller can move to a position at which the intermediate roller touches the moisturizing roller and the water-supplying roller and to a position at which the intermediate roller is away from at least one of the moisturizing roller and the water-supplying roller.

10. The paper moisturizing apparatus of claim 1, wherein the moisturizing rollers in pair are detachable.

11. A paper moisturizing apparatus comprising a pair of moisturizing rollers each having a porous layer and form a paper-delivering nip area, an intermediate roller which supplies water to at least one of the moisturizing rollers in pair from the surface thereof, and a water-supplying roller which supplies water to the intermediate roller.

12. The paper moisturizing apparatus of claim 11, wherein the intermediate roller can move to a position at which the intermediate roller touches the moisturizing roller and the water-supplying roller and to a position at which the intermediate roller is away from at least one of the moisturizing roller and the water-supplying roller.

13. The paper moisturizing apparatus of claim 11, wherein the moisturizing rollers in pair are detachable.

14. An image forming apparatus comprising an image forming section which transfers toner onto paper and forms a toner image on the paper, a fixing device which heats and presses the paper having the toner image to fix the toner image, and the paper moisturizing apparatus of claim 1.

15. The image forming apparatus of claim 14, wherein the water-supplying device comprises a water-supplying roller which has a porous layer and supplies water to the moisturizing roller in contact therewith.

16. The image forming apparatus of claim 15, wherein the regulating device comprises a regulating member which is in press-contact with the water supplying roller and regulates the quantity of water in the water-supplying device.

17. The image forming apparatus of claim 16, wherein the regulating member can move to touch and detach from the water-supplying roller.

18. The image forming apparatus of claim 14, wherein the regulating device comprises a regulating member which is in press-contact with the moisturizing roller and regulates the quantity of water in the moisturizing means.

19. The image forming apparatus of claim 18, wherein the regulating member can move to touch and detach from the moisturizing roller.

20. The image forming apparatus of claim 14, wherein the water-supplying device comprises a water-supplying roller and an intermediate roller which is in contact with the water-supplying roller and at least one of the moisturizing rollers.

21. The image forming apparatus of claim 20, wherein the intermediate roller can move to a position at which the intermediate roller touches the moisturizing roller and the water-supplying roller and to a position at which the intermediate roller is away from at least one of the moisturizing roller and the water-supplying roller.

22. The image forming apparatus of claim 14, wherein the moisturizing rollers in pair are detachable.

23. The image forming apparatus of claim 14, wherein a post-processing device is provided to post-process the paper moistened by the paper moisturizing apparatus.

24. A recording-medium moisturizing apparatus comprising:
a first and a second moisturizing members each of which has a porous layer, wherein a recording medium is delivered by the first and second moisturizing members;
a water-supplying device which supplies water to at least one of the moisturizing members from the surface thereof; and
a regulating device which regulates the quantity of water to be supplied to the moisturizing roller from the water supplying device.
